(19) United States
(12) Patent Application Publication
(10) Pub. No.: US 2011/0090341 A1
(43) Pub. Date: Apr. 21, 2011

(54) INTRUDING OBJECT DETECTION SYSTEM AND CONTROLLING METHOD THEREOF

(75) Inventors: Shigeru IKEWADA, Hamura-si (JP); Miyuki FUJII, Suginami-ku (JP)

(73) Assignee: HITACHI KOKUSAI ELECTRIC INC., Tokyo (JP)

(21) Appl. No.: 12/907,418

(22) Filed: Oct. 19, 2010

(30) Foreign Application Priority Data
Oct. 21, 2009 (JP) 2009-242453

(51) Int. Cl. H04N 7/18

(52) U.S. Cl. 348/152; 348/E07.085

(57) ABSTRACT

An intruding object detection system including a first drive unit for moving an image pickup unit in a pan direction, a second drive unit for moving the pickup unit in a tilt direction, a third drive unit for moving the pickup unit to zoom in and out, and a control unit for detecting an image of a target object in a video signal supplied from the pickup unit, and controlling the first and second drive units to move the pickup unit in the pan and tilt directions to place the image of the target object to a center of a video screen in accordance with movement and change of the target object, and cause the third drive unit to zoom in or out so that the image of the target object is permitted to be maintained at a predetermined size.

### INCORPORATION BY REFERENCE

The present application claims priority from Japanese application JP 2009-242453 filed on Oct. 21, 2009, the content of which is hereby incorporated by reference into this application.

### BACKGROUND OF THE INVENTION

The present invention relates to an intruding object detection system for capturing a target object in the screen center and tracking it by conducting panning, tilting and zooming on an image pickup unit.

In recent years, a technique of detecting and tracking a target object on the basis of a video signal supplied from a camera has been known as the optical technique spreads. For example, in a tracking apparatus, it is possible to conduct processing on a video signal supplied from a camera, specify a target object, and track the target object.

In JP-A-2001-60269 (U.S. Pat. No. 6,687,386), an object tracking method and an object tracking apparatus provided with a function of tracking a target object by using a template matching function are disclosed.

### SUMMARY OF THE INVENTION

The conventional art in JP-A-2001-60269 has the function of conducting matching processing by using a template image of a target object and thereby tracking the target object. However, there is a problem that tracking becomes difficult when the target object moves and the image of the target object in the screen becomes too small or too large or disappears to the left or right.

An object of the present invention is to provide an intruding object detection system capable of surely tracking a target object on the screen while capturing it in the center of the screen.

In order to attain the object, an intruding object detection system according to one aspect of the present invention is an intruding object detection system including a first drive unit for mounting an image pickup unit including an object lens and moving the image pickup unit in a pan direction, a second drive unit for moving the image pickup unit in a tilt direction, a third drive unit for moving the image pickup unit to conduct zoom in and zoom out, and a control unit for detecting an image of a target object in a video signal supplied from the image pickup unit, and exercising control to cause the first drive unit and the second drive unit to move the image pickup unit respectively in the pan direction and the tilt direction so as to place the image of the target object at a center of a video screen in accordance with a movement and a change of the target object, and cause the third drive unit to conduct zoom in or zoom out so as to permit the image of the target object to be maintained at a predetermined size.

This intruding object detection system not only simply tracks a target object but also moves the direction of a camera in the pan direction and the tilt direction to place the target object at the center of the screen. In addition, the intruding object detection system is capable of tracking the target object surely by zooming in or zooming out the camera to maintain the ratio in area of an image of the target object to the screen.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example of a configuration of an intruding object detection system according to an embodiment of the present invention;

FIG. 2 is a block diagram showing a configuration of a camera, an electromotive camera pan and tilt head and an image processing apparatus in the intruding object detection system according to the embodiment of the present invention;

FIG. 3 is an explanation diagram showing a configuration of the camera and the electromotive camera pan and tilt head in the intruding object detection system according to the embodiment of the present invention;

FIG. 4 is a flow chart showing an example of tracking processing in the intruding object detection system according to the embodiment of the present invention;

FIG. 5 is a flow chart showing details of intruding object detection processing in the intruding object detection system according to the embodiment of the present invention;

FIG. 6 is a flow chart showing an example of camera control processing for capturing a target to be tracked onto a screen in a monitoring terminal in the intruding object detection system according to the embodiment of the present invention;

FIG. 7 is an explanation diagram for explaining an example of a changeover screen for changing over a target to be tracked to another target in the monitoring terminal in the intruding object detection system according to the embodiment of the present invention; and

FIG. 8 is an explanation diagram for explaining an example of a changeover screen for changing over a target to be tracked to another target in the monitoring terminal in the intruding object detection system according to the embodiment of the present invention.

### DESCRIPTION OF THE EMBODIMENTS

Hereafter, embodiments according to the present invention will be described with reference to the drawings.

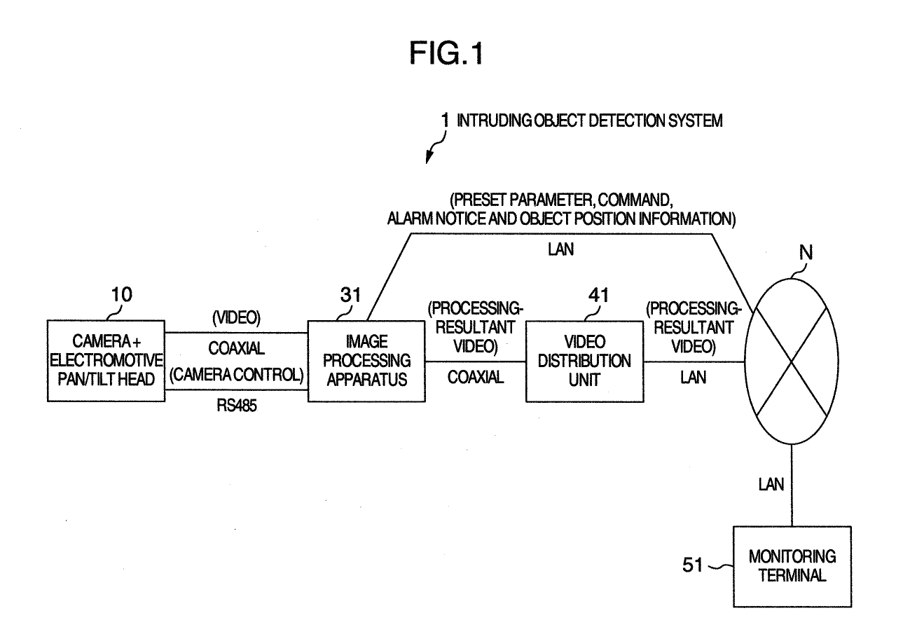

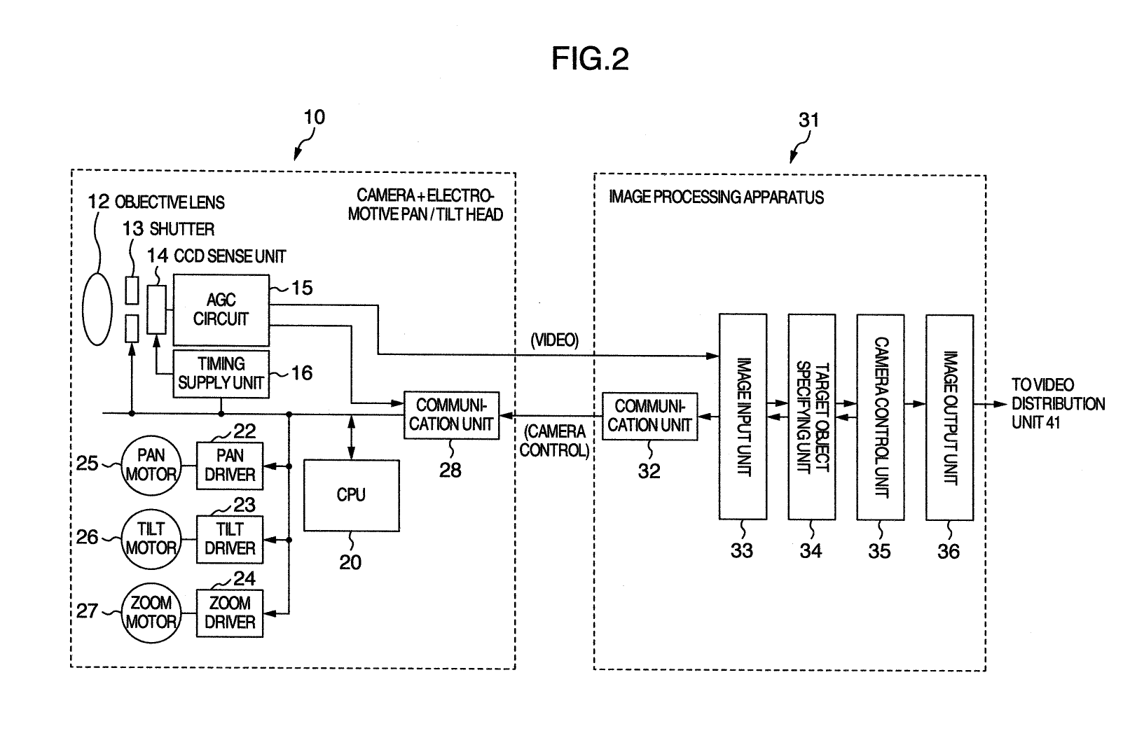

First, an intruding object detection system according to an embodiment of the present invention will be described in detail with reference to FIGS. 1 and 2. As shown in FIG. 1, an intruding object detection system 1 according to an embodiment of the present invention includes an electromotive camera pan and tilt head 10 provided with a camera unit, an image processing apparatus 31 connected to the electromotive camera pan and tilt head 10 by a connection cable and formed of a control unit and a storage area which will be described in detail later to conduct various kinds of image processing, a video distribution unit 41 connected to the image processing apparatus 31 by a connection cable, and a monitoring terminal 51 connected to the image processing apparatus 31 and the video distribution unit 41 via a LAN (Local Area Network) or the like and formed of a personal computer or the like.

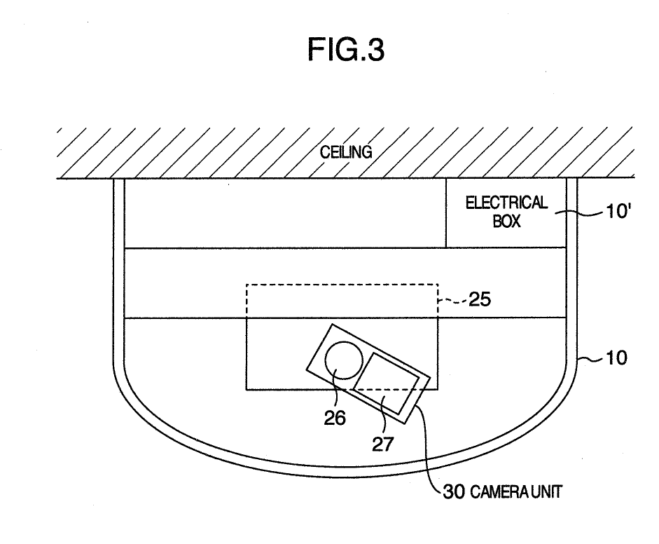

The electromotive camera pan and tilt head 10 has, for example, an exterior view shown in FIG. 3. The electromotive camera pan and tilt head 10 includes an object lens 12, a shutter 13, and a solid-state image pickup element 14 formed of CCDs (Charge Coupled Devices) to receive incident light passed through the shutter 13 and output a detection signal depending upon the incident light, which form an image pickup unit. In addition, the electromotive camera pan and tilt head 10 includes an AGC (Auto Gain Control) circuit 15, a timing supply unit 16 for supplying a timing signal to the solid-state image pickup element 14, a CPU 20 for controlling processing operation of the whole electromotive camera pan and tilt head 10, a communication unit 28 connected to the CPU 20 via a data bus, and a camera unit 30 serving as the image pickup unit shown in FIG. 3. These electrical blocks are provided in, for example, an electrical box 10′ shown in FIG. 3.

The image processing apparatus 31 includes a communication unit 32 for conducting communication with the electromotive camera pan and tilt head 10 or the like, an image input unit 33 for conducting, for example, A/D (Analog/Digital) conversion on a video signal supplied via the communication unit 32, an target object specifying unit 34 for storing a part of the video signal converted to a digital signal by the image input unit 33 into a storage area as an image signal of an intruding object (target object), a camera control unit 35 for conducting, for example, pan control, tilt control and zoom control on the camera unit 30 to track the target object, and an image output unit 36 for conducting image processing on the video signal converted by the image input unit 33 and supplying a resultant signal to the subsequent video distribution unit 41.

The electromotive camera pan and tilt head 10 further includes a pan motor 25 such as a stepping motor for moving the camera unit 30 in the pan direction, a pan driver 22 for driving the pan motor 25, a tilt motor 26 such as a stepping motor for moving the camera unit 30 in the tilt direction, a tilt driver 23 for driving the tilt motor 26, a zoom motor 27 for moving the position of the object lens 12 in the camera unit 30 to zoom-in or zoom-out the object lens 12 in the camera unit 30, and a zoom driver 24 for driving the zoom motor 27.

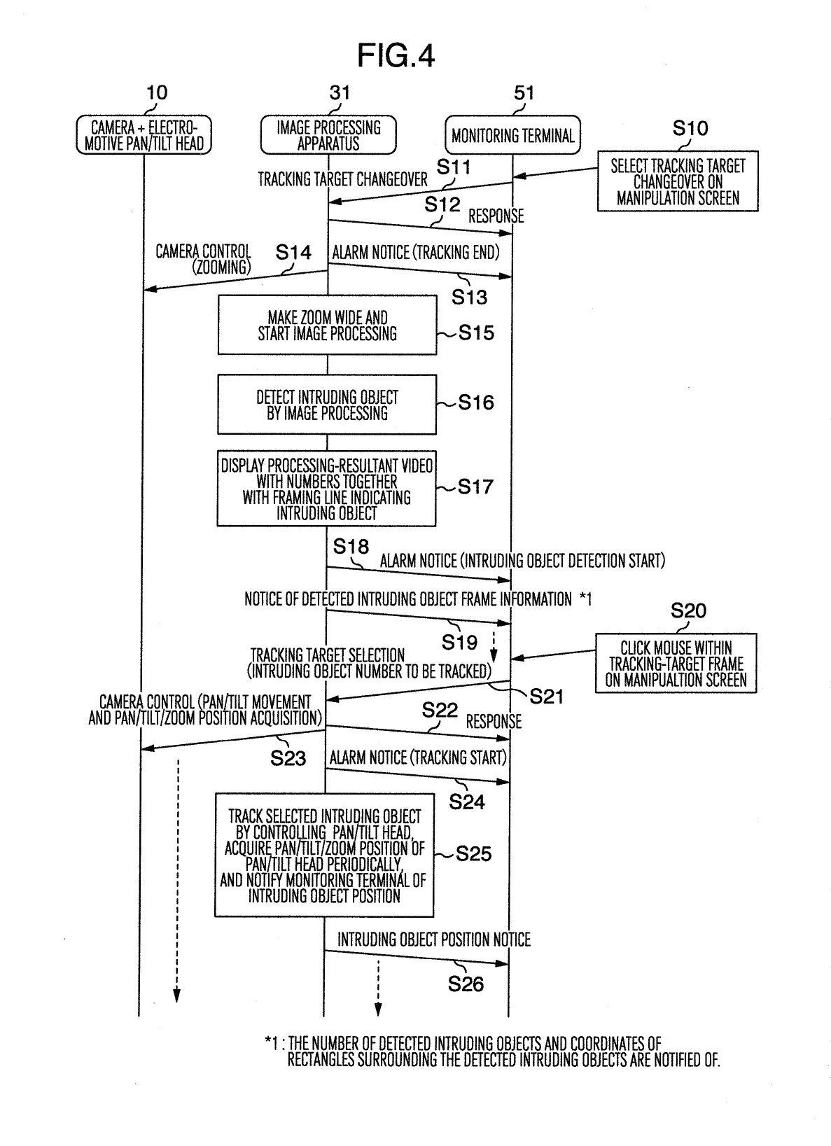

A control unit in the image processing apparatus connected to the electromotive camera pan and tilt head via the cable conducts image processing such as, for example, sharpness processing, contrast processing, gamma correction, white balance processing and pixel addition processing, and in addition conducts control processing shown in FIGS. 4 to 6 in conjunction with the electromotive camera pan and tilt head 10.

In addition, the video distribution unit 41 is connected to the image processing apparatus 31 via a coaxial cable, and the video distribution unit 41 stores a video signal or an image signal acquired from the image processing apparatus 31 into the storage area, or supplies the video signal or the image signal to the monitoring terminal 51 via the network.

The monitoring terminal 51 is, for example, a PC (Personal Computer) having a function of conducting communication via the network. As described later, a user can give a command signal for specifying a target object on a screen and tracking the target object by, for example, a mouse pointing manipulation.

### (Operation)

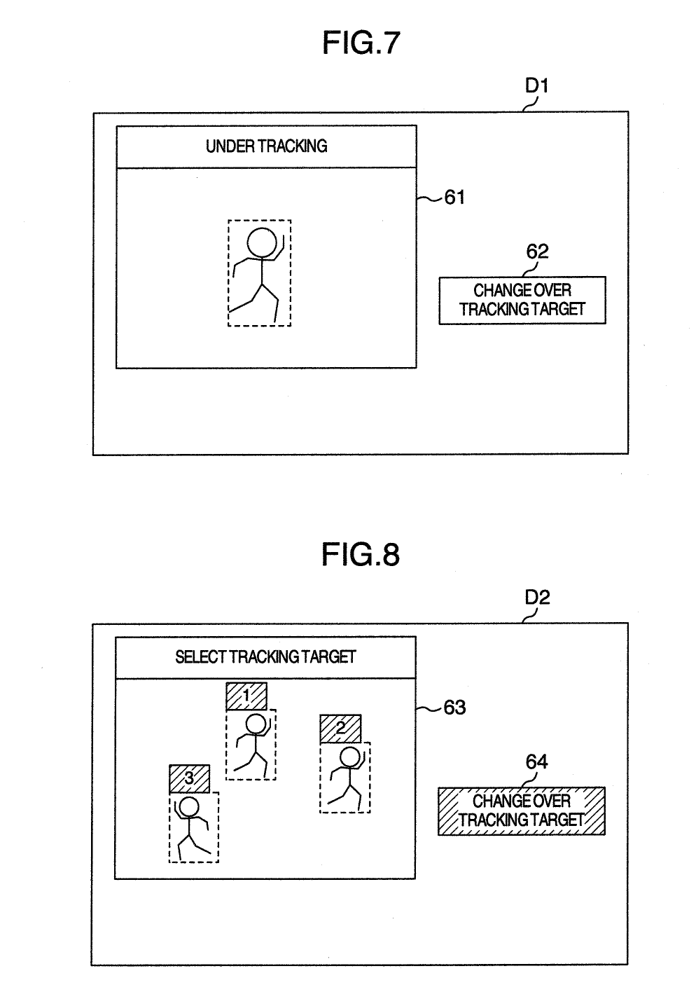

Hereafter, operation of the intruding object detection system 1 having the above-described configuration, i.e., operation of the electromotive camera pan and tilt head 10, the image processing apparatus 31, the video distribution unit 41 and the monitoring terminal 51 will be described in detail with reference to flow charts shown in FIGS. 4 to 6 and manipulation screens shown in FIGS. 7 and 8.

As shown in a flow chart in FIG. 4, first, the target object specifying unit 34 in the image processing apparatus 31 in the intruding object detection system 1 processes the video signal supplied from the electromotive camera pan and tilt head 10 of the camera and detects an intruding object (for example, an intruding person). If the target object specifying unit 34 in the image processing apparatus 31 detects an intruding object, then the camera control unit 35 shifts an operation mode to a tracking mode, notifies the monitoring terminal 51 of the shift to the tracking mode, and operates in conjunction with the electromotive camera pan and tilt head 10. As described in detail later, the camera control unit 35 conducts pan operation and tilt operation of the electromotive camera pan and tilt head 10 to bring the detected intruding object to the center of the image. And the camera control unit 35 controls the zoom to bring the image of the intruding object to the center of the screen and cause the size of the detected intruding object in the screen to become a size suitable for the tracking. The camera control unit 35 continues tracking until it loses sight of the intruding object for a certain time period.

On the other hand, upon receiving the tracking mode shift notice from the image processing apparatus 31, the monitoring terminal 51 displays a video of the target object which is being tracked obtained as a result of processing conducted by the image processing apparatus, on a screen D1 shown in FIG. 7, and validates a tracking target changeover button 62 on the screen.

If an operator depresses the tracking target changeover button 62 on the screen of the monitoring terminal 51 in the state of the screen D1 (step S10), then a tracking target changeover command is transmitted from the monitoring terminal 51 to the image processing apparatus 31 (step S11). Upon receiving the tracking target changeover command, the target object specifying unit 34 in the image processing apparatus 31 sends a response signal to the monitoring terminal 51 (step S12). In the monitoring terminal 51, the tracking target changeover button is changed to invalidity display 64 on a display screen D2 as shown in FIG. 8.

Upon receiving the tracking target changeover command, the target object specifying unit 34 and the camera control unit 35 in the image processing apparatus 31 stop the tracking and notifies the monitoring terminal 51 of alarm (step S13). After acquiring the current zoom ratio from the electromotive camera pan and tilt head 10, the camera control unit 35 in the image processing apparatus 31 controls the CPU 20 and the zoom driver 24 in the electromotive camera pan and tilt head 10 to attain, for example, half of the current zoom ratio (step S14), As a result, the zoom is made wide, and image processing is started ((step S15). In other words, the target object specifying unit 34 in the image processing apparatus 31 shifts from the tracking mode to an intruding object detection mode, and detects an intruding object by means of image processing (step S16).

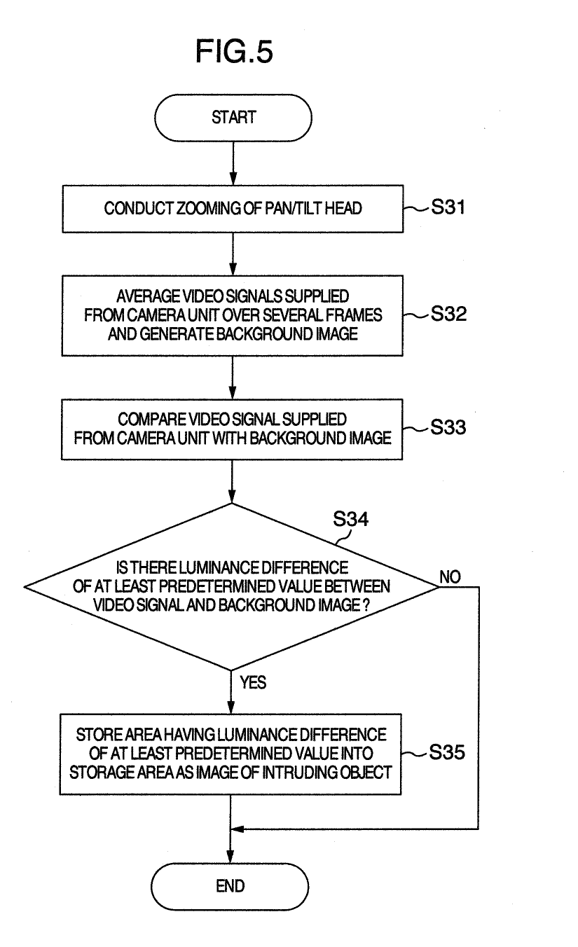

This intruding object detection processing will now be described in detail with reference to the flow chart shown in FIG. 5. After receiving the tracking target changeover command, the target object specifying unit 34 and the camera control unit 35 in the image processing apparatus 31 conduct zoom operation of the electromotive camera pan and tilt head 10 (step S31), and receive a video signal acquired by the solid-state image pickup element 14 in the electromotive camera pan and tilt head 10, via the AGC circuit 15 in order to detect an object in a short time. And the target object specifying unit 34 in the image processing apparatus 31 averages the input video over several frames and generates a new background image (step S32). Then, after generating the background image, the target object specifying unit 34 in the image processing apparatus 31 compares luminance of the background image with luminance of the current input image and obtains a difference (step S33). The target object specifying unit 34 in the image processing apparatus 31 judges whether there is a part where the difference in luminance distribution between the background image and the video signal of the current input is at least a certain fixed threshold (step S34). If there is a part where the difference in luminance distribution between the background image and the video signal of the current input is at least the certain fixed threshold, then the target object specifying unit 34 in the image processing apparatus 31 judges the image of this part as an image of an intruding object and stores it into the storage area (step S35).

Upon storing the image of the intruding object into the storage area as a target image according to the procedure described heretofore, the target object specifying unit 34 in the image processing apparatus 31 generates a picture with a framing line surrounding an object detected as the intruding object (the display screen D1 in FIG. 7) and a picture with numbers (numerals) (the display screen D2 in FIG. 8) superposed in a screen including image information of the intruding object (step S17), and gives a notice to the monitoring terminal 51 as alarm (step S18). In addition to this, the target object specifying unit 34 in the image processing apparatus 31 periodically notifies the monitoring terminal 51 of the number of objects currently being detected and a range of the coordinates of the framing line (X and Y coordinates at the top left and bottom right of the framing line surrounding each object) on the video screen (step S19). The target object specifying unit 34 continues these kinds of processing until it receives a tracking target selection command from the monitoring terminal 51.

On the other hand, a control unit in the monitoring terminal 51 displays the display screen D1 on the screen of the monitoring terminal 51, and waits for the tracking target changeover button 62 in the screen to be mouse-clicked. Upon detecting that the tracking target changeover button 62 is mouse-clicked by the operator, the control unit in the monitoring terminal 51 displays a tracking target selection picture 63 as shown in FIG. 8, and waits for the operator to mouse-click on the screen. Upon detecting that a choice on the tracking target selection picture 63 on the video is mouse-clicked (step S20), the control unit in the monitoring terminal 51 judges whether the clicked position is within the coordinate range of the framing line surrounding an intruding object notified of by the image processing apparatus 31. If the clicked position is within the coordinate range, then the control unit in the monitoring terminal 51 notifies the image processing apparatus 31 of a number representing a selected object together with the tracking target selection command via a communication line such as a LAN (step S21).

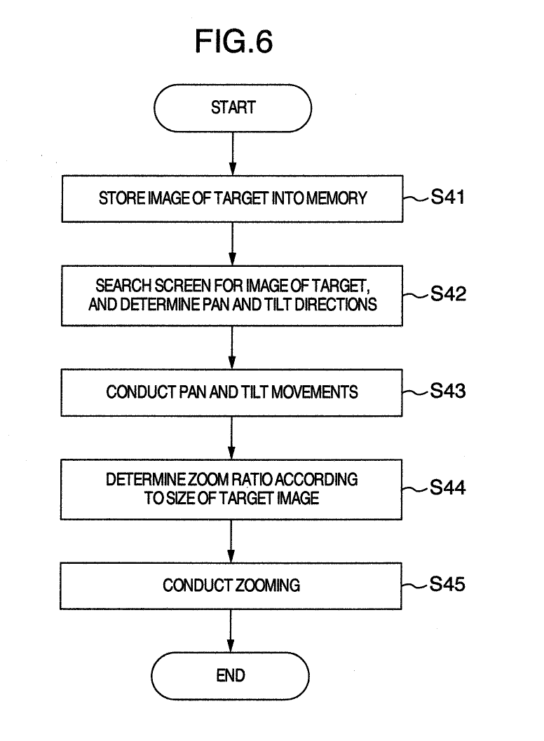

Upon receiving the tracking target selection command from the monitoring terminal 51, the target object specifying unit 34 and the camera control unit 35 in the image processing apparatus 31 send a response to the monitoring terminal 51 to notify the monitoring terminal 51 that the target object specifying unit 34 has received the tracking target selection command (step S22). Then, the target object specifying unit 34 and the camera control unit 35 in the image processing apparatus 31 shift to the tracking mode shown in the flow chart in FIG. 6, and sends an alarm notice to the monitoring terminal 51 to notify it that tracking is started (step S24). And the camera control unit 35 in the image processing apparatus 31 sends a control signal to control the pan/tilt in the electromotive camera pan and tilt head 10 so that the object selected by the target object specifying unit 34 is brought to the image center, and sends a control signal to the electromotive camera pan and tilt head 10 to control the zoom so that the size of the selected object on the video becomes a size suitable for the tracking (step S23). As a result, the camera control unit 35 in the image processing apparatus 31 tracks the intruding object, acquires the current position of the pan/tilt/zoom of the electromotive camera pan and tilt head 10 periodically (step S25), and notifies the monitoring terminal 51 of the position of the intruding object (step S26).

In other words, as shown in the flow chart in FIG. 6, the camera control unit 35 in the image processing apparatus 31 stores the image of the intruding object to be tracked into the storage area of the target object specifying unit 34 (step S41), and searches the current video signal supplied from the electromotive camera pan and tilt head 10 for the image of the intruding object stored in the storage area. Upon detecting this, the camera control unit 35 in the image processing apparatus 31 determines the pan direction, the tilt direction and the movement quantity to bring the image of the intruding object to center of the screen (step S42). The pan direction, the tilt direction and the movement quantity may be determined according to, for example, a method described in US 2002/0171742. The content of US 2002/0171742 is hereby incorporated into this application by reference in its entirety. And the camera control unit 35 in the image processing apparatus 31 conducts pan movement and tilt movement of the camera unit 30, which is the image pickup unit, by using the pan driver 22 and the tilt driver 23 according to the determined directions and the movement quantity (step S43).

Then, the camera control unit 35 in the image processing apparatus 31 determines the zoom ratio to cause the image of the intruding object to assume a certain predetermined size which is neither too large or not too small as compared with the screen, on the basis of the size in units of meter of the intruding object stored previously at the time of tracking start and the visual field size in units of meter in the horizontal direction of the screen calculated from the current tilt position and zoom position (step S44). The camera control unit 35 in the image processing apparatus 31 controls the zoom driver 24 in accordance with the zoom ratio and exercises zoom control of the camera unit 30 (step S45). Owing to such a control operation conducted by the target object specifying unit 34 and the camera control unit 35 in the image processing apparatus 31, the image of the intruding object is kept at nearly the center of the screen as an image having a suitable size.

As described in detail heretofore, when changing over the tracking target, the intruding object detection system according to an embodiment of the present invention makes the zoom wide angle, then averages the input video over several frames, thereby generates a background image, and detects an object in a short time on the basis of a difference between the background image and the current input image.

Upon detecting an intruding object, the control unit in the image processing apparatus 31 outputs a video obtained by superposing a framing line surrounding the detected intruding object and a number on an input video, and periodically notifies the monitoring terminal 51 of the number of the detected intruding objects and coordinates of framing lines each surrounding respective intruding object. The monitoring terminal 51 displays the distributed video on the screen. Upon judging as to in which of the detected object framing lines a mouse-clicked position on the video is present, the monitoring terminal 51 notifies the image processing apparatus 31 a number of a tracking target. As a result, it is made possible to readily change over the tracking target by a manipulation of mouse-clicking on the video displayed on the screen of the monitoring terminal 51.

As for various embodiments described heretofore, it is possible to execute a plurality of them at the same time. Although those skilled in the art can implement the present invention in accordance with the description, it is easy for those skilled in the art to think of various modifications of these embodiments. Even if those skilled in the art do not have an inventive ability, they can apply the modifications to various embodiments. Therefore, the present invention extends over a wide range as long as it is not contradictory to the disclosed principle and novel features, and the present invention is not restricted to the embodiments described above.

It should be further understood by those skilled in the art that although the foregoing description has been made on embodiments of the invention, the invention is not limited thereto and various changes and modifications may be made without departing from the spirit of the invention and the scope of the appended claims.

1. An intruding object detection system comprising:
a first drive unit for mounting an image pickup unit including an object lens and moving the image pickup unit to a pan direction;
a second drive unit for moving the image pickup unit to a tilt direction;
a third drive unit for moving the image pickup unit to conduct zoom in and zoom out; and
a control unit for detecting an image of a target object in a video signal supplied from the image pickup unit, and exercising control to cause the first drive unit and the second drive unit to move the image pickup unit respectively in the pan direction and the tilt direction so as to place the image of the target object in a center of a video screen in accordance with a movement and a change of the target object, and cause the third drive unit to conduct zoom in or zoom out so as to cause the image of the target object to maintain a predetermined size.

2. The intruding object detection system according to claim 1, wherein
the control unit generates a background image signal by averaging the video signal over a plurality of frames, and compares the background image signal with a current video signal, and
if a difference exceeding a predetermined quantity is detected between the background image signal and the current video signal is detected, then the control unit judges that an intruding object exists.

3. The intruding object detection system according to claim 2, wherein
the control unit generates a video having a frame image surrounding the target object which is the intruding object detected by the control unit superposed onto a picture of the video signal, and displays a resultant video on the screen, and
upon detecting that the frame image is specified by a given manipulation signal, the control unit newly tracks a target object corresponding to the specified frame image by using the first drive unit, the second drive unit and the third drive unit.

4. A method for controlling an intruding object detection system including a first drive unit for moving an image pickup unit having an object lens to a pan direction, a second drive unit for moving the image pickup unit to a tilt direction and a third drive unit for zooming in or zooming out the image pickup unit, comprising the steps of:
detecting an image of a target object in a video signal supplied from the image pickup unit;
generating pan and tilt control signals for controlling pan and tilt quantities of the image pickup unit to place an image of the target object in a center of a video screen in accordance with a movement and a change of the target object;
moving the image pickup unit in the pan direction and the tilt direction by using the first drive unit and the second drive unit in accordance with the pan and tilt control signals;
generating a zoom control signal to cause the image of the target object to maintain a predetermined size; and
zooming in or zooming out the image pickup unit by using the third drive unit in accordance with the zoom control signal.

5. The method for controlling an intruding object detection system according to claim 4, wherein
the step of detecting an image of a target object comprises generating a background image signal by averaging the video signal over a plurality of frames, comparing the background image signal with a current video signal, detecting a part which has a difference in at least a predetermined quantity between the background image signal and the current video signal, and judging the part to be an image of an intruding object.

6. The method for controlling an intruding object detection system according to claim 5, further comprising the steps of:
generating a video by superposing a frame image surrounding the intruding object onto a picture of the current video signal, and displays a resultant video in the screen;
detecting that the frame image is specified by a manipulation signal from outside; and
responsive to the detection, newly tracking a target object corresponding to the specified frame image by using the first drive unit, the second drive unit and the third drive unit.
